(19) United States
(12) Patent Application Publication
(10) Pub. No.: US 2008/0159233 A1
(43) Pub. Date: Jul. 3, 2008

(54) Method and Apparatus for Managing Buffers During Transitions Between Heterogenous Networks

(75) Inventors: Guyves Achtari, Ottawa (CA); Michel Ouellette, Orleans (CA)

Correspondence Address: Anderson Gorecki & Manaras LLP, 33 NAGOG PARK, ACTON, MA, 01720, US

(73) Assignee: Nortel Networks Limited

(21) Appl. No.: 11/621,280

(22) Filed: Jan. 9, 2007

Related U.S. Application Data
(63) Continuation-in-part of application No. 11/618,760, filed on Dec. 30, 2006, now abandoned.

(51) Int. Cl. H04Q 7/00

(52) U.S. Cl. 370/332

(57) ABSTRACT

A method and apparatus that enables a mobile device to seamlessly transition between packet-switched wireless networks to while maintaining access to a resource is described. The invention includes a delay measurement component, a buffer management component and a mobile device component. The delay measurement component actively measures downlink packet delays from a packet duplication point to each of the interfaces of the mobile device with a single time reference. A buffer management component compares the measured delays to identify a delay difference and uses the delay difference to manage packet delivery on each network during the transition. A mobile device component includes functionality for assisting in the delay measurement and organizing packets received during transition. As a result of the above mechanisms, delay measurement and buffer management, “slips” and “repeats” due to network transition are minimized, which guarantees an enhanced Quality of Experience (QoE).

### RELATED APPLICATIONS

This application is a continuation-in-part application and claims priority under 35 U.S.C. §120 to U.S. patent Ser. No. 11/618,760 filed Dec. 30, 2006.

### FIELD OF THE INVENTION

This invention relates generally to the field of network mobility and more particularly to a method and apparatus enabling mobile devices to seamless transition between networks.

### BACKGROUND OF THE INVENTION

Handheld wireless devices are essentially hand held radios that communicate by exchanging radio frequency signals with network access points using predefined signaling protocols. Each handheld device may include multiple interfaces for communicating using a variety of different wireless networks. A typical handheld wireless device is a mobile phone which includes a cellular interface that allows the phone to connect to a Public Switched Telephone Network (PSTN) via a cellular network such as a Global System for Mobile Communications (GSM) network. A handheld device may also include interfaces that allow the device to communicate using General Packet Radio Service (GPRS) protocols in a GPRS network, Wi-Fi (IEEE 802.11) protocols in a Wi-Fi network, WiMAX (IEEE 802.16) protocols in a WiMAX network or Bluetooth protocols for Bluetooth exchanges. The different wireless networks (Wi-Fi, WiMAX, etc.) are interconnected via gateways, where a gateway is a node on a network that serves as an entrance to another network. Wireless access points or base stations transmit radio frequency signals to indicate the existence of a wireless network to a wireless device. A wireless device will associate (or connect) with one of the wireless access points or base stations to gain access to the wireless network. Once the wireless device has made a connection to a wireless network, the wireless device may access resources in the wireless network, as well as resources in networks connected to the wireless network via gateways.

However radio frequency signals have a limited transmission range, and when a mobile device moves it may move out of range of the access point or base station that connects it to the desired resource. In order to maintain resource access, the mobile device must connect to another access point or base station. The access point or base station may be part of the original network, or may be an entirely different network. It is desirable that the transition between access points and/or networks occur as seamlessly as possible to minimize disturbances in the connection and therefore provide a high quality of experience to a user. To ensure that no packets are dropped during transition between the first and second network a gateway may forward duplicated packets to the device over both networks. One problem with this approach is that it results in a large number of duplicated packets being received at the device, which may overburden buffering capabilities of the device and make it difficult for the device to sort through and order packets.

### SUMMARY OF THE INVENTION

According to one aspect of the invention, a method for controlling the transmission of packets to a device that communicates with a first network over a first interface and a second network over a second interface, and is transitioning from the first network to the second network includes the steps of determining, from a reference point, a first link delay to the first interface on the first network and a second delay to the second network on the second interface, and selectively forwarding a packet on at least one of the first and second networks in response to the measured first link delay and measured second link delay. The reference point may be any device or group of devices with synchronized clocks. In one embodiment the link delays are calculated in response to a plurality of round trip and cross round trip delay measurements of packets forwarded between the reference point and the interfaces of the device. In an alternate embodiment the delays are calculated by multi-casting timestamps to the different interfaces of the device and identifying an offset in delays between packets having matching timestamps at the device.

The delay measurements of the present invention may be used to control pointers to a multi-threshold buffer which controls the forwarding of packets to different interfaces associated with the first and second network at the common reference point. Buffer pointers are controlled to minimize gaps and duplicates in packet transmission that occur in the transmissions between the reference point and the device to provide a seamless transition experience for the user at the device during the transition between the first and second network. In one embodiment, delay measurement frequency and associated adjustment of buffer thresholds is conditioned to smooth buffer threshold transitions to further improve the quality of experience to the user.

According to another aspect of the invention, a buffer at a reference device comprises a plurality of buffer entries, each buffer entry for storing a packet that is to be delivered to a mobile device that is transitioning from a first network to a second network, wherein the buffer includes a first threshold pointer pointing to a first packet that is forwarded over the first network during the transition to the second network and a second threshold pointer indicating a first packet to be forwarded over the second network during the transition, wherein the first threshold pointer and second threshold pointer are related to a difference in delay between the reference point and the mobile device on each of the first and second networks.

According to another aspect of the invention, a client device includes at least two interfaces and means for receiving a packet at a first interface from a reference point, determining that the packet is a Cross Round Trip Delay Measurement (CRTDM) packet, determining an outgoing interface from the CRTDM packet and forwarding the packet to the reference point using the outgoing interface.

These and other aspects of the invention will be described in more detail with regard to the attached figures.

### BRIEF DESCRIPTION OF THE FIGURES

FIG. 1 illustrates a communication system 10 including networks coupled by gateways of the present invention which include functionality for seamlessly transitioning mobile devices between heterogeneous networks;

FIG. 2 is a flow diagram that illustrates several exemplary steps that may be performed when controlling transition of communications to a device from a first network associated with a first interface of the device and a second network associated with a second interface of the device;

FIG. 3A is a diagram illustrating delay paths in two networks, and FIG. 3B is a flow diagram illustrating exemplary steps that may be performed to determine link delays in the paths of FIG. 3A;

FIG. 4A is a diagram that illustrates exemplary fields of a Cross Round Trip Delay Measurement (CRTDM) packet of the present invention that may be used to determine link delays using the process of FIG. 3B;

FIGS. 4B and 4C are diagrams that illustrates exemplary fields of a Delay Measurement request and response packet that may be used to determine link delays using the process of FIG. 5B;

FIG. 5A is a diagram illustrating delay measurement paths in two networks and FIG. 5B is a flow diagram illustrating exemplary steps that may be performed at the reference point and transitioning device during delay measurements;

FIG. 6A is a diagram illustrating packet flow from a gateway to a device over different networks during transition;

FIG. 6B is a diagram of a multi-threshold packet buffer of the present invention which may be used to control packet flow across the networks of FIG. 3A during transition;

FIG. 7 is a diagram illustrating several exemplary components that may be included in a client mobile device to support the present invention;

FIG. 8 is a flow diagram illustrating exemplary steps that may be performed by a management layer of the mobile device of FIG. 5.

### DETAILED DESCRIPTION

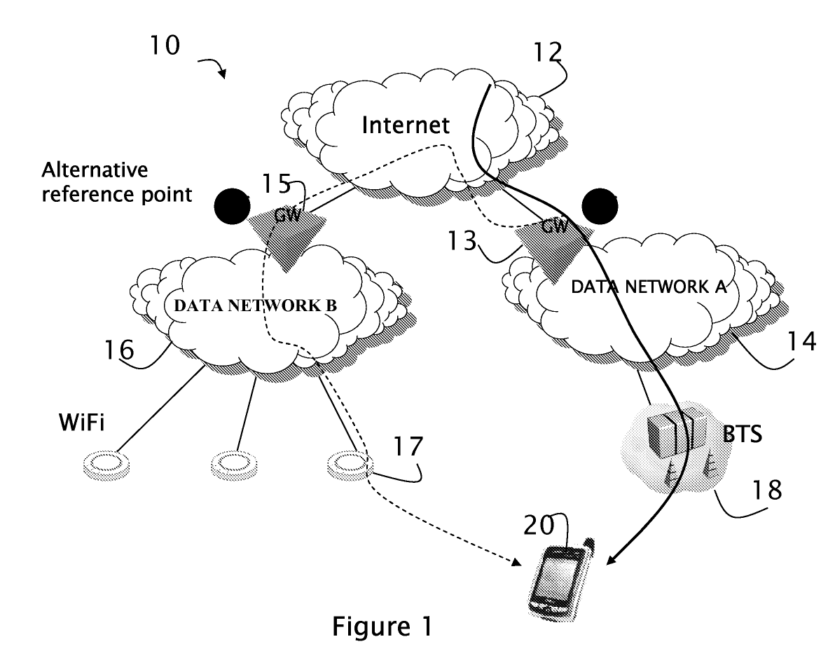

Referring now to FIG. 1 a communication system 10 is shown to include a plurality of networks 12, 14 and 16 coupled by gateways such as gateway 13 and 15. For the purposes of this application, a gateway is a group of one or more local or distributed devices that share clock synchronization. Each network consists of two or more devices that are linked in order to share resources, exchange files, or allow electronic communications. The devices in a network may be linked through cables or telephone lines (i.e., wire-line networks) or radio waves, satellites, or infrared light beams (i.e. wireless networks). Wireless networking hardware uses radio frequencies to transmit information between the individual devices with each device including a wireless network adapter. A wireless network gateway, hub or router is used to bridge the wireless network to wire-line networks such as the Public Switched Telephone Network (PSTN) or Public Switched Data Network (PSDN).

There are a variety of communication protocols that are used to enable wireless communication. Traditional mobile networks include hardware and software supporting cellular communications including base stations and Mobile Telephone Switching Offices (MTSOs) which may be used to forward cellular communications to mobile devices, such as mobile phones, using analog or digitized radio frequency signals using any one of the known cellular communication protocols. Digitized signals may be encoded using Time Division Multicast Access (TDMA) for use in a Global System for Mobile Communications (GSM) network or using Carrier Division Multiplex Access (CDMA) in the International Standard 95 networks (IS-95) networks. Cellular networks are ‘circuit switched’ networks, with each circuit, or connection, being setup using the call signaling protocols of the associated cellular network and being assigned time-slots or codes for use in maintaining the communication channel.

A packet switched network uses packet-switched connections, (or circuit-switched connections with overlaid packet-switched services) for exchanging data with wireless devices. Unlike a circuit-switched network, a packet-switched connection is an “always on” connection that remains active as long as the phone is within range of the service. In packet-switched network, communications are broken down into packets which include a header and a payload. The header includes information regarding the source and destination of the communication, as well as other information related to the packet protocol. A well-known packet switching protocol is the Internet Protocol. Many mobile wireless applications use packet-switching technology for exchanging data and voice communications. The present invention is directed at a method for seamlessly transitioning a mobile device between packet based networks, where the packet based networks include both packet-switched networks and others, such as VoIP, GPRS, 3G and 4G networks which provide packet based services overlaid on a circuit switched network Thus the present invention may be used to transition between two packet-switched networks, between two circuit-switched networks overlaid with packet-switched services, or between a packet-switched and circuit switched network that implements packet based services.

The communication system 10 of FIG. 1 is shown to include a variety of packet-switched networks, including an Internet Network 12, data network A (14) and data network B (16). The Internet is a worldwide collection of computer networks, cooperating with each other to exchange data using a shared protocol. Through telephone wires and satellite links, Internet users can share information in a variety of forms. The size, scope and design of the Internet allows users to connect easily through ordinary personal computers and local phone numbers, exchange electronic mail (E-mail) with friends and colleagues with accounts on the Internet, post information for others to access, and update it frequently, access multimedia information that includes sound, photographic images and even video and access diverse perspectives from around the world. For the purpose of the present invention, any of the operations, communications or data will be referred to as a ‘resource’ that is accessible to a mobile device that is able to connect to the Internet.

Data network A 14 and data network B 16 are wireless networks connected to the Internet 12 via gateways 13 and 15. Each network may be a wireless network that either uses a different wireless protocol. Alternatively, the networks may be wireless networks that use the same protocol but are administered by different entities. The wireless networks use General Packet Radio Service (GPRS) protocols in a GPRS network, Wi-Fi (IEEE 802.11) protocols in a Wi-Fi network, WiMAX (IEEE 802.16) protocols in a WiMAX network or Bluetooth protocols for Bluetooth exchanges. WiMAX is a specification for fixed broadband wireless metropolitan access networks (MANs) that use a point-to-multipoint architecture. Bluetooth is a short-range radio technology aimed at simplifying communications among Internet devices and between devices and the Internet. The present invention may be used to support transitions between any such networks, as well as any other current or future network supporting packet-switched services.

GPRS is a standard for wireless communications which supports a wide range of bandwidths, is an efficient use of limited bandwidth and is particularly suited for sending and receiving small bursts of data, such as e-mail and Web browsing, as well as large volumes of data. Assuming data network B is a GPRS network, connection to the GPRS network may be achieved via base station 18.

Wi-Fi specifies an over-the-air interface between a wireless client and a base station or between two wireless clients. Wireless clients gain access to a Wi-Fi network by associating with access points such as access point 17.

The present invention allows a multi-mode mobile device such as mobile device 20 to seamlessly transition between packet-switched wireless networks while maintaining access to a resource that is available to both networks. A multi-mode mobile device is any mobile device that includes at least two interfaces for communicating with different networks, where the networks comprise different communication technologies and/or are administered by different entities.

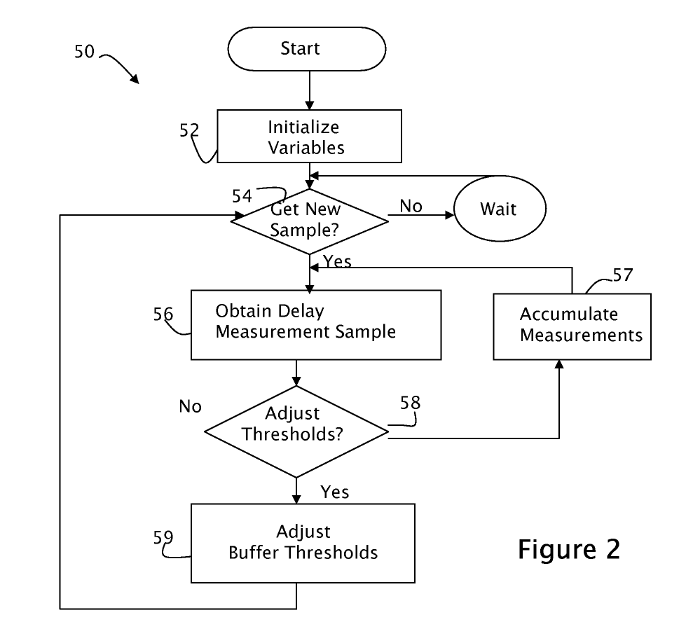

FIG. 2 is a flow diagram that illustrates different steps that may be performed during a process 50 of seamlessly transitioning between two networks. At step 52, any variables which are used to perform delay measurements are initialized. At step 54, it is determined whether a delay sample should be taken. An initial sample may be taken when the mobile device detects a new network, when the network detects a new device, when the mobile device or the network detects a degradation in signal on the currently utilized network, or some other trigger. At step 56, the reference point measures a delay to each interface of the mobile device. As mentioned above, the reference point includes one or more devices that share clock synchronization. Measurement techniques such as those that will be described below may be performed by one or more devices at the reference point during step 56 to obtain exact delays to the mobile device.

At step 58 it is determined whether buffer thresholds should be adjusted. It may be desirable to smooth buffer control over time by accumulating and averaging a number of delay measurements before adjusting buffer. Therefore if it is determined at step 58 that it is not time to adjust the buffer threshold, the delay measurements may be advantageously accumulated at step 57. Further filtering and conditioning of the delay measurements may also be performed in this step. It should be noted that accumulation and conditioning of delay measurements is not a requirement of the present invention.

If, however, it is determined at step 58 that buffer thresholds should be modified, then at step 59 pointers to buffers at the reference point are controlled to forward packets to at least one of the first and second networks in accordance with the delay measurements. As will be described in more detail below, in a preferred embodiment a multi-threshold buffer is used for controlling the forwarding of packets to each of the interfaces.

In an exemplary embodiment of the present invention, a mechanism for providing seamless transition between networks by a multi-mode device includes a delay measurement component, a buffer management component and a mobile device component. The delay measurement component actively measures downlink packet delays from a packet duplication point to each of the interfaces of the mobile device with a single time reference. A buffer management component compares the measured delays to identify a delay difference and uses the delay difference to manage packet delivery on each network during the transition. The mobile device management component includes functionality for assisting in the delay measurement and organizing packets received during transition. Using the above mechanisms, delay measurement and buffer management, “slips” and “repeats” due to network transition are minimized, which guarantees an enhanced Quality of Experience (QoE). Each of the components of the present invention will now be described in more detail.

Delay Measurement

When transitioning a multi-mode mobile device between wireless IP networks it is realized that an accurate identification of the delay to the device on the originating network (i.e., the network to which the mobile device is currently connected) and the destination network (i.e., the network that the mobile device is transitioning to) can greatly assist the seamless transition of the device between networks. The delay measurement can be used to determine when transition is complete, and to determine how many packets to duplicate to ensure that quality of experience remains high while duplication is minimized. Because the device is a mobile device, the delays will change as the device moves towards the new network. The precision and frequency of measurements facilitates the minimization of slips and repeats and allows a high quality of experience to be achieved.

1. Delay Calculation Using Round Trip/Cross Round Trip Delay Measurements:

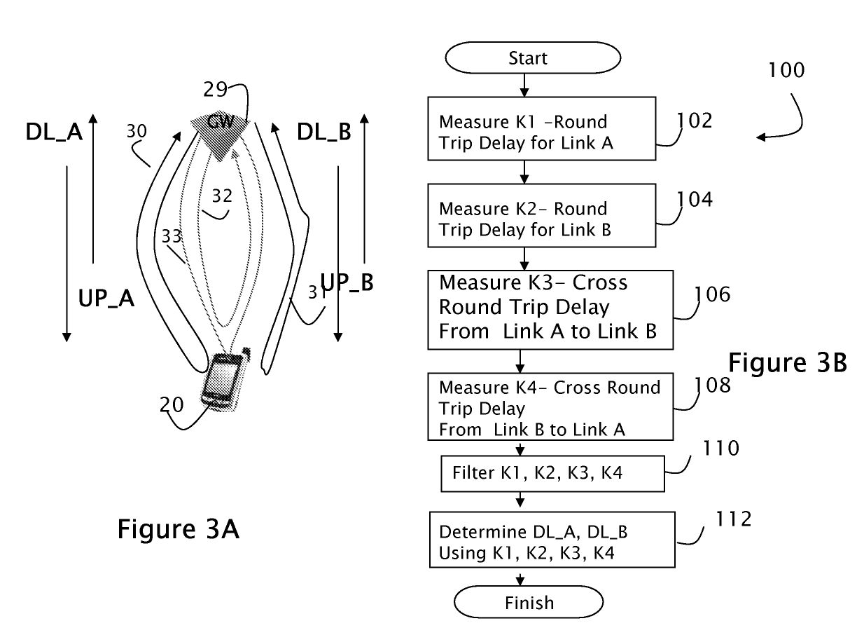

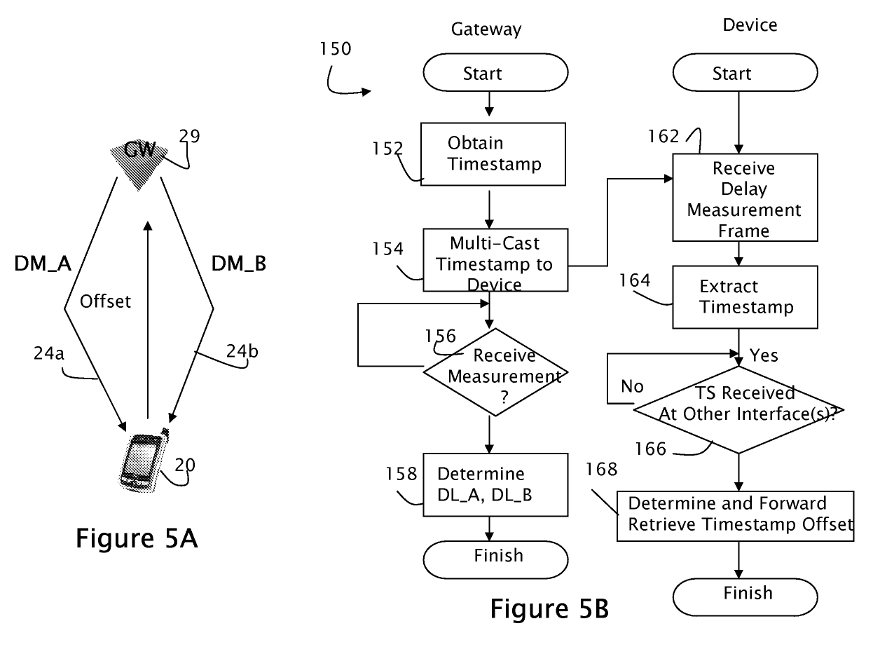

FIGS. 3B and 5B describe two different processes that may be used to accurately identify instantaneous downlink delays between a reference point and a device using two different networks. Although these two methods are described, it should be understood that other processes for measuring downlink delay are considered equivalents that may be used in the network transition process and system of the present invention. Thus the present invention is not limited to the examples of delay measurement that will now be described.

According to one embodiment of a delay measurement process, four delay measurements are taken from a common reference point in the network to the multi-mode mobile device. The reference point may be any gateway (or similar device such as a hub or router) that connects the originating and destination network. For example, in FIG. 1 one common reference point is the gateway 13, while an alternative reference point is gateway 15. The delay measurement may measure the delay to the different interfaces associated with each of the original and destination networks. As the mobile device 20 transitions from wireless network A to wireless network B, packets that flow from the Internet through network A to the interface associated with network A on the device 20 will be transitioned to flow through network B to the interface associated with network B on the device 20.

FIG. 3A is a simplified diagram illustrating the flow of delay measurement packets of the present invention during the delay measurement process illustrated in FIG. 2B. Two types of delay measurements are performed; round trip delay measurements and cross-round trip delay measurements. Existing round trip delay measurement techniques known to those in the art (such as the PING or TRACEROUTE command in the TCP/IP protocol stack), or other timestamp based methods may be used to provide a round trip delay measurement. In FIG. 3A, path 30 illustrates a round trip delay path for measuring delay on network A, and path 31 is a round trip delay path for measuring delay on network B.

However, a round trip delay measurement alone is insufficient for determining an actual downlink (from reference point to the device) or uplink (from the device back to the reference point) delay, as the round trip delay will only provide a total delay, but does not indicate which portion of the round trip delay is due to the downlink delay and which portion of the delay is due to the uplink delay. Downlink paths and uplink paths may not traverse identical paths; it is desirable to determine which portion of the round trip delay may be attributed to the individual uplink and downlink channels, but this cannot be determined through round trip delay measurements alone.

A second type of delay measurement is therefore performed which provides sufficient data for precise calculation of uplink and downlink delays in each network. The second type of delay measurement is referred to herein as a ‘cross round trip delay measurement,’ and is performed by issuing a Cross Round Trip Delay Measurement (CRTDM) packet from the reference point to the device on each of the networks. The CRTDM packet may be an Internet Control Message Protocol (ICMP) packet, or be a packet that has similar functionality to the ICMP control packets. The CRTDM packet is a specialized packet which includes information that tells the receiving device to forward a packet to the reference point using a specified interface. For example a CRTDM packet may include a header that indicates that it is a CRTDM type and also indicates an interface to use to forward the packet back to the reference point. The interface that is indicated in the header is generally the opposite interface that was used to receive the packet; for example, if the CRTDM packet is received at the mobile device at an interface associated with the original network, the cross round trip delay measurement packet will be forwarded back to the reference point using an interface associated with the destination network.

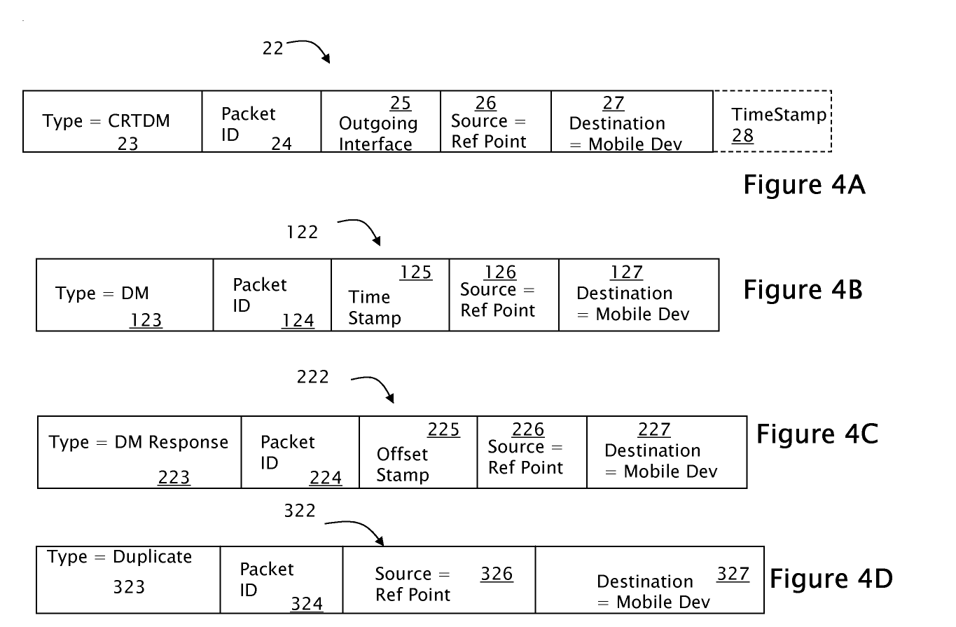

Referring briefly to FIG. 4A, one embodiment of a CRTDM packet header 22 is shown to include a CRTDM type field 23, an packet identifier 24 (which may be a sequence number, counter or other identifier that will identify the packet to the reference point when it is returned), an outgoing interface identifier 25, a source identifier 26 and destination identifier 27. The CRTDM may also advantageously include a time stamp, generated by the reference point and indicating the time that the reference point issued the CRTDM packet.

Referring back to FIG. 3A, a first cross round trip delay measurement path 32 is shown to be forwarded from the reference point 29 to mobile device 20 on network A, received at the interface of device 20 associated with network A, and forwarded from the device on the interface associated with network B towards the reference point 29 on network B. A second cross round trip delay measurement path 33 is shown to be forwarded from the reference point 29 to mobile device 20 on network B, received at the interface of device 20 associated with network B, and forwarded from the device on the interface associated with network A towards the reference point 29 on network A. It may be desirable to filter or otherwise condition the round trip and cross-round trip measurement prior to delay calculations to minimize the impact of interference on delay measurements.

The delay measurements results in the following 4 Equations:

DL_{—}A+UP_{—}A=K1

DL_B+UP_B=K2

DL_{—}A+UP_{—}B=K3

DL_{—}B+UP_{—}A=K4

Where K1, K2, K3 and K4 are measured constants. As a result, four equations with four variables are provided, and the individual downlink delays DL_A and DL_B can be determined using known mathematical techniques.

FIG. 3B is a flow diagram illustrating a process 100 that may be performed by a reference point device to determine downlink delays to a mobile device. In FIG. 3B, network A and network B refer to different networks which are both coupled to the reference point and the mobile device. At step 102 a round trip delay between the reference point and the mobile device on network A is measured. At step 104 a round trip delay between the reference point and the mobile device on network B is measured. At step 106 a first cross round trip delay is measured which originates at network A, traverses the mobile device and is returned on network B. At step 108 a second cross round trip delay is measured which originates on network B, traverses the mobile device and is returned on network A. At step 110, the delay measurements are advantageously filtered to remove artifacts that arise due to noise and other interference during the measurement process. At step 112, the resulting measurements can then be substituted into the above equations to solve for the DL_A (the downlink delay of network A) and DL_B (the downlink delay of network B).

2. Delay Calculation Using Timestamp Delay Measurements

Referring now to FIGS. 5A and 5B, a second method of calculating link delays between a reference point and interfaces of a multi-mode device will now be described. In this delay measurement embodiment, as shown in FIG. 5A, a Delay Measurement (DM) packet is forwarded to each interface of the device 20 from reference point 29.

Exemplary fields of a DM packet of the invention are shown in FIG. 4B. The DM packet in this embodiment includes a timestamp indicating when the packet was forwarded to the device from the reference point.

Referring back to FIG. 5A, when the device receives a DM packet at an interface, it stores the receive timestamp at which the packet is received. The device may wait to receive other packets with the same timestamp/sequence number information on another interface. The device may then provide the gateway with information regarding the offset between the receive time stamps. In one embodiment the device may calculate the offset, or in another embodiment the device may simply forward received timestamps as they are captured when the DM packet was received at each interface, allowing the gateway to determine delays based on the returned information.

For example, FIG. 5B is a flow diagram of processes 150 that may be performed by the gateway and device during the delay measurement process described above with regard to FIG. 5A. At step 152 the gateway obtains a timestamp and inserts it into a DM packet such as DM packet 122 of FIG. 4B, and then forwards the packet at step 154 to the device. At step 162 the device receives the DM packet, identifies it as a DM packet and stores a received timestamp, indicating the time the packet was received at the device. In the embodiment of FIG. 5B, the device waits until another packet with the same timestamp (and/or sequence number) at another interface. In one embodiment, a duplication bit (such as that shown in FIG. 4D) is used to signal to the device that the packet has been duplicated, and indicate to the device that it should look for the duplicated packet. At step 168, the offset between retrieved timestamps is calculated and relayed to the gateway, for example using a packet such as that of FIG. 4C. Because both received timestamps are generated using a common clock, the difference in delay between the paths can be accurately determined.

Because the device 20 is a mobile device, the delay measurements will vary as the mobile device changes position during the transition between networks. As a result, it is desirable that the measurements be performed frequently once it is determined that the device is to transition between networks. The various circumstances and methods by which a mobile device may transition between networks are numerous; for example, the mobile device or the network may detect a reduction in power of a signal, or may begin to experience packet loss or the like. The mobile device periodically scans the wireless environment to detect existing networks (which periodically broadcast their presence), and may decide to transition to another network with stronger signals or less load. Whatever the reasons and methods by which a mobile device determines that it is to transition between networks, the decision to transition is signaled by the device or by the network, for example by the request to associate with the new network. In a preferred embodiment, once the gateway detects the impending network transition, the above described delays are frequently measured to precisely reflect the relationship between the mobile device and the respective networks. As will now be described in more detail, the delay measurements can be used to manage the delivery of packets over the original and destination networks in a manner that minimizes transmission gaps and duplicated packets.

Buffer Management

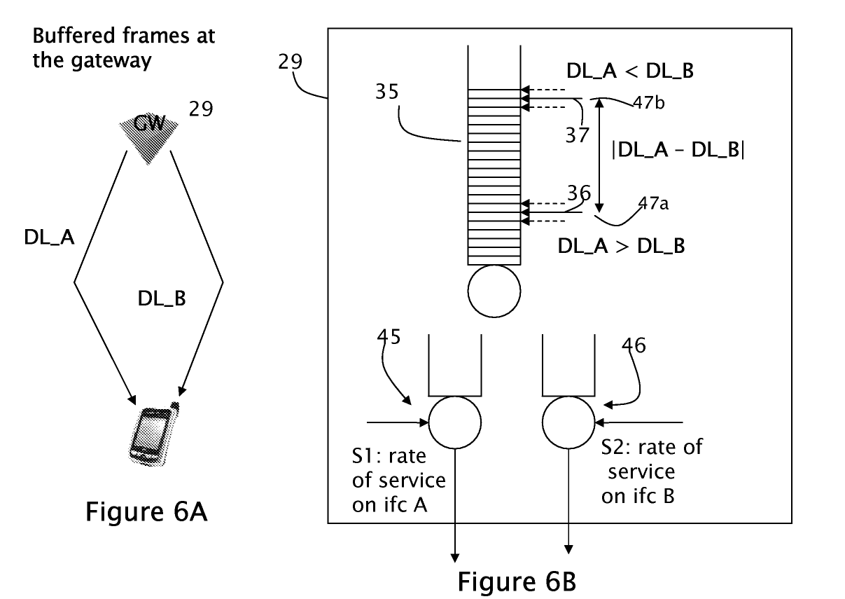

Referring now to FIG. 6A, it is appreciated that as the mobile device 20 transitions from network A to network B, the gateway 20 must manage the delivery of packets to the mobile device in such a manner to minimize the number of late arriving packets (duplicate_) and the number of packets that arrive too soon (gaps) The gateway maintains a buffer of all packets that are to be delivered to the mobile device 20. According to one aspect of the invention, a multi-threshold buffer is provided which uses delay information provided by the delay measurement component of the invention to identify thresholds in the buffer that are associated with the network transition.

FIG. 6B illustrates a gateway 29 including a multi-threshold buffer 35 of the present invention. The multi-threshold buffer includes two pointers 36 and 37. Each pointer points to the next frame to send on each of the interfaces 45 and 46. The distance between the two pointers is equivalent to delay difference measured between the two downstream links. The buffers are used to control the selection of one or the other of the two interfaces based on the measured delay difference. Duplicate packets may be provided on both interfaces during the transition.

The flow of packets out of interfaces 45 and 46 may be further controlled according to service parameters S1 and S2 of the network. S1 and S2 can be used to provide different bandwidths or jitters. Should it be desired to insert additional delay into a packet stream on any of the interfaces, idle frames may be inserted at each of the interface.

Pointer 47a points to a threshold for packets that are destined to the device over a first interface. Pointer 47b points to the threshold in the buffer identifying packets that are destined to the second interface. Which pointer is associated with which interface is dependent upon the delays of each of the downstream links.

For example, if the delay on network A is greater than the delay on network B (assume DL_A is 40 ms and DL_B is 20 ms), and the device is transitioning from network A to network B, then the buffer logic of FIG. 6B uses pointer 47b as the threshold for packets that are to be delivered over network A. In the above example where the delay difference is 20 ms, the buffer management logic of the gateway effectively forwards a ‘later’ packet over network A, continuing to forward packets over network B to ensure that the device does not get starved for packets during the transition. If the delay on network B is smaller than the delay over network A, and the user is transitioning to network A, then pointer 47a indicates the threshold for entries in the buffer that are to be forwarded to network A. Idle packets may be inserted as necessary in the network A interface to minimize confusion from packets arriving too early at the device on network A.

Accordingly it can be seen that the precise delay measurements can be used to improve gateway buffer management to allow packets to be more accurately directed towards appropriate interfaces. In addition, by increasing the accuracy in which packets are associated with interfaces, the number of duplicated packets may be reduced while still maintaining a high quality of experience but reducing the burden of sorting through duplicated packets at the transitioning mobile device.

Mobile Device Management

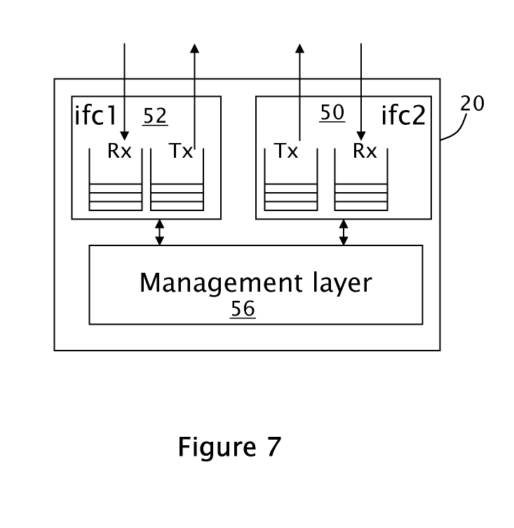

FIG. 7 is a block diagram illustrating several components of a mobile device 20 that supports the present invention. The mobile device 20 is a multi-mode or multi-mode device, meaning that it includes two or more interfaces (such as interfaces 50 and 52) that permit the device to communicate with different types of wireless networks. Each interface may include buffering, such as receive (Rx) buffers for temporary storage of packets received at the associated interface and transmit (Tx) buffers for temporary storage of packets to be forwarded out of the interface.

As mentioned above, one aspect of the present invention is the ability to precisely measure the delay from a network reference point to the device 20. The measurement includes a Cross Round Trip Delay Measurement (CRTDM) which is performed using CRTDM packets similar to that shown in FIG. 3. To support such measurements, each mobile device 20 of the present invention includes a specialized management layer 56. The management layer 56 is comprised of a combination of hardware and software components that perform specified tasks and interacts with the operating systems of the mobile device 20. The management layer 56 sorts between duplicate frames that arrive on both interfaces during transition and otherwise manages the transition between the two networks. In addition, the management layer 56 detects, modifies and forwards CRTDM packets as described in the flow diagram of FIG. 6 to assist in reference point delay measurement.

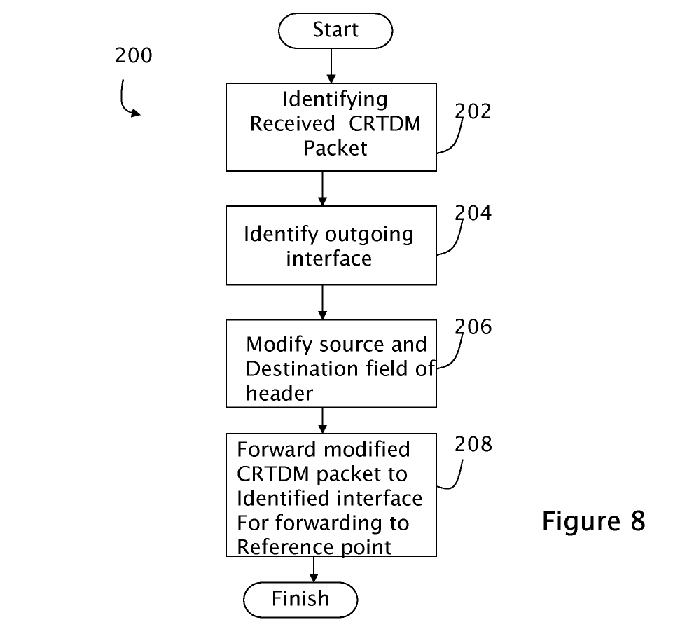

Referring now to FIG. 8 a process 200 for managing CRTDM packets includes the step (202) of detecting a received CRTDM at a first interface of the mobile device. At step 204, the management layer extracts the outgoing interface identifier from the header of the CRTDM packet to identify an outgoing interface. At step 206 the management layer modifies the source and destination addresses of the header, replacing the source address with the address of the mobile device and the destination address with the reference point address. At step 208 the mobile device places the modified packet in the transmit queue of the interface identified in the outgoing interface field 25 for return to the reference point.

Accordingly various components of a method and apparatus that enables seamless transition of mobile IP devices between heterogeneous networks has been shown and described. A delay measurement component actively measures downlink packet delays from a packet duplication point to each of the interfaces of the mobile device with a single time reference. Various embodiments of delay measurement components have been described. A buffer management component compares the measured delays to identify a delay difference and uses the delay difference to manage packet delivery on each network during the transition. A mobile device component includes functionality for assisting in the delay measurement and organizing packets received during transition. As a result of the above mechanisms, delay measurement and buffer management, “slips” and “repeats” due to network transition are minimized, which guarantees an enhanced Quality of Experience (QoE).

Having described various embodiments of the invention, it will be appreciated that many of the above figures are flowchart illustrations of methods, apparatus (systems) and computer program products according to an embodiment of the invention. It will be understood that each block of the flowchart illustrations, and combinations of blocks in the flowchart illustrations, can be implemented by computer program instructions. These computer program instructions may be loaded onto a computer or other programmable data processing apparatus to produce a machine, such that the instructions which execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using baseband signaling or broadband signaling techniques, including carrier wave signaling techniques, such as over computer or telephone networks via a modem

While the invention is described through the above exemplary embodiments, it will be understood by those of ordinary skill in the art that modification to and variation of the illustrated embodiments may be made without departing from the inventive concepts herein disclosed. It should be understood that the descriptions are representative only, other functional delineations or additional steps and components can be added by one of skill in the art. Accordingly, the invention should not be viewed as limited except by the scope and spirit of the appended claims.

1. A method for controlling the transmission of packets to a device that is transitioning from a first network to a second network includes the steps of:
measuring link delays to the device using each of the first and second networks; and
selectively directing packets to either the first network or second network in response to the measured link delays.

2. The method of claim 1 wherein the step of selectively directing packets to either the first network or second network includes the step of controlling pointers of a multi-threshold buffer to identify packets to forward over the first and second networks.

3. The method of claim 2 wherein the step of controlling the pointers of the multi-threshold buffer includes the step of periodically modifying the pointers in accordance with the measured link delays.

4. The method of claim 1 including the step of filtering the measured link delays.

5. The method of claim 1 wherein the step of measuring link delays includes the step of measuring round trip delays and cross round trip delays to the device over the first and second network and wherein the step of measuring cross round trip delays, includes the step of transmitting, by a reference point, a Cross Round Trip Delay Measurement (CRTDM) packet to the device.

6. The method of claim 5 wherein the CRTDM packet identifies an outgoing interface for the device to use when returning the CRTDM packet to the reference point.

7. The method of claim 6 wherein the step of measuring the round trip delays and cross round trip delays includes the steps of:
measuring a first round trip delay between a reference point and a first interface of the device in the first network;
measuring a second round trip delay between the reference point and a second interface of the device in the second network;
measuring a first cross round trip delay of a packet sent from the reference point to the device on the first network and back to the reference point on the second network;
measuring a second cross round trip delay to the device from the reference point to the device on the second network and from the device to the reference point on the first network; and
wherein the step of selectively directing directs packets to either the first network or second network in response to the first round trip delay, second round trip delay, first cross round trip delay and second cross round trip delay.

8. The method of claim 5, wherein the steps of measuring round trip delays, cross round trip delays and selectively directing are performed at a common reference point device.

9. The method of claim 8 further including the step of determining a first link delay to the mobile device through the first network and a second link delay to the mobile device through the second network using the measured round trip delays and measured cross round trip delays.

10. The method of claim 9 wherein the reference point device includes a multi-threshold buffer for storing packets to be delivered to the device, wherein the buffer comprises a plurality of pointers which are controlled in response to the first link delay and second link delay.

11. The method of claim 10 wherein the pointers of the multi-threshold buffer identify packets for forwarding from different interfaces of the reference point.

12. A method for controlling the delivery of packets to a device as the device is transitioning between a first network and a second network includes the steps of:
receiving a Cross Round Trip Delay Measurement (CRTDM) packet at a first interface from a reference point, the CRTDM packet including an outgoing interface identifier; and
forwarding a modified version of the CRTDM packet to the reference point over the outgoing interface.

13. The method of claim 12 wherein the modified version of the CRTDM packet is modified to direct the CRTDM packet at the reference point.

14. The method of claim 12 wherein the outgoing interface is different than the first interface.

15. The method of claim 12 wherein the outgoing interface uses a different communication protocol than the first interface.

16. A buffer at a reference point device comprises:
a plurality of buffer entries, each buffer entry for storing a packet that is to be delivered to a mobile device that is transitioning from a first network to a second network, wherein the buffer includes a first threshold pointer pointing to a first packet that is forwarded over the first network during the transition to the second network and a second threshold pointer indicating a first packet to be forwarded over the second network during the transition;
wherein the first threshold pointer and second threshold pointer are related to a difference in delay between the reference device and the mobile network on each of the first and second networks.

17. A client device comprising:
at least two interfaces;
means for receiving a packet at a first interface from a reference point, determining that the packet is a Cross Round Trip Delay Measurement (CRTDM) packet, identifying an outgoing interface from the CRTDM packet and forwarding the packet to the reference point using the outgoing interface.

18. A mechanism for determining a first delay to a device over a first network and a second delay to the device over the second network includes:
means for measuring round trip delays to the device over the first and second networks;
means for measuring cross round trip delays to the device over the first and second networks; and
means for determining the first delay and the second delay using the round trip delays and the cross round trip delays, wherein the first and second delays are used to control the delivery of packets to the device over each of the first and second networks.
